(19) United States
(12) Patent Application Publication
(10) Pub. No.: US 2023/0134186 A1
(43) Pub. Date: May 4, 2023

(54) MACHINE LEARNING DATA GENERATION DEVICE, MACHINE LEARNING MODEL GENERATION METHOD, AND STORAGE MEDIUM

(71) Applicant: Kabushiki Kaisha Yaskawa Denki, Kitakyushu-shi (JP)

(72) Inventors: Ryohei SUZUKI, Tokyo (JP); Tsuyoshi Yokoya, Kitakyushu-shi (JP); Ryo Masumura, Kitakyushu-shi (JP); Hiroki Tachikake, Kitakyushu-shi (JP)

(21) Appl. No.: 18/088,766

(22) Filed: Dec. 26, 2022

Related U.S. Application Data
(63) Continuation of application No. PCT/JP2020/029255, filed on Jul. 30, 2020.

(51) Int. Cl. G06N 3/094

(52) U.S. Cl. CPC G06N 3/094

(57) ABSTRACT

Provided a machine learning data generation device including: at least one processor; and at least one memory device that stores a plurality of instructions which, when executed by the at least one processor, causes the at least one processor to execute: acquiring , in association with a predetermined label actual time series information; executing physical simulation of generating a plurality of pieces of virtual time series information; identifying parameter values based on the plurality of pieces of virtual time series information and the actual time series information, and to associate the identified parameter values with the label; generating a new parameter value and the label based on the identified parameter values; generating virtual time series information corresponding to a new internal state by executing physical simulation through use of the new parameter value; and generating new machine learning data.

### CROSS-REFERENCE TO RELATED APPLICATION

The present disclosure contains subject matter related to that disclosed in International Patent Application PCT/JP2020/029255 filed in the Japan Patent Office on Jul. 30, 2020, the entire contents of which are hereby incorporated by reference.

### BACKGROUND OF THE INVENTION

1. Field of the Invention

The present invention relates to a machine learning data generation device, a machine learning device, a machine learning model generation method, and a program.

2. Description of the Related Art

In order to cause a machine which executes a physical operation to operate through use of machine learning, it is required to execute the machine learning through use of machine learning data (such as vibration waveform) corresponding to various modes which can actually occur. However, in order to acquire sufficient learning data, it is required to actually operate an actual machine under various conditions to execute the machine learning, and tremendous amounts of labor and time may be required.

### SUMMARY OF THE INVENTION

A problem to be solved by the present invention is to provide a machine learning data generation device, a machine learning device, a machine learning model generation method, and a program which use physical simulation without actually operating a subject machine to identify parameters representing an internal state of the subject machine, to thereby acquire machine learning data appropriately labeled.

According to one aspect of the present invention, there is provided a machine learning data generation device including: at least one processor; and at least one memory device that stores a plurality of instructions which, when executed by the at least one processor, causes the at least one processor to execute: acquiring, in association with a predetermined label, actual time series information indicating an operation state of a subject machine being one of a machine or an electric circuit; executing physical simulation of generating a plurality of pieces of virtual time series information by sequentially calculating a virtual state after a unit time based on each of a plurality of parameters representing an internal state of the subject machine; identifying one or more parameter values from the plurality of parameter values based on the plurality of pieces of virtual time series information and the actual time series information, and to associate the identified one or more parameter values with the predetermined label; generating a new parameter value and the predetermined label corresponding to the new parameter value based on the one or more identified parameter values; generating virtual time series information corresponding to a new internal state by executing the physical simulation through use of the new parameter value; and generating new machine learning data by associating the virtual time series information corresponding to the new internal state with the predetermined label corresponding to the new parameter value.

Further, the machine learning data generation device according to another aspect of the present invention, the at least one memory device further stores the parameter value that is possible for each type of the predetermined label in association with the predetermined label, and the new parameter value is generated based on the parameter stored in the at least one memory device.

Further, in the machine learning data generation device according to another aspect of the present invention, the predetermined label corresponding to the new parameter value is determined based on a relationship between the new parameter value and a group of the parameter values stored in the at least one memory device and corresponding to each predetermined label.

Further, in the machine learning data generation device according to another aspect of the present invention, the predetermined label indicates whether the operation state of the subject machine is normal or abnormal, and the new parameter value corresponding to the predetermined label indicating that the operation state is abnormal is selectively generated.

Further, in the machine learning data generation device according to another aspect of the present invention, the new parameter value is indicated as a position on a parameter distribution diagram representing a distribution of the one or more parameter values associated with the predetermined label, and the parameter value that is generated as the new parameter value is a parameter value indicated by a position at which a predetermined number of the parameter values exist within a predetermined range on the parameter distribution diagram.

Further, in the machine learning data generation device according to another aspect of the present invention, the virtual time series information corresponding to the new internal state is generated by a generative adversarial network (GAN) based on a result of the physical simulation executed through use of the new parameter value.

Further, according to another aspect of the present invention, there is provided a machine learning model generation method including: acquiring, in association with a predetermined label, actual time series information indicating an operation state of a subject machine being one of a machine or an electric circuit; executing physical simulation of generating a plurality of pieces of virtual time series information by sequentially calculating a virtual state after a unit time based on each of a plurality of parameters representing an internal state of the subject machine; identifying one or more parameter values from the plurality of parameter values based on the plurality of pieces of virtual time series information and the actual time series information, and associating the identified one or more parameter values with the predetermined label; generating a new parameter value and the predetermined label corresponding to the new parameter value based on the one or more parameter values identified in the identifying of the one or more parameter values; generating virtual time series information corresponding to a new internal state by executing the physical simulation through use of the new parameter value; generating new machine learning data by associating the virtual time series information corresponding to the new internal state with the predetermined label corresponding to the new parameter value; and executing, based on the new machine learning data, learning of a neural network model being a neural network which receives the virtual time series information as input and outputs the predetermined label.

Further, according to another aspect of the present invention, there is provided a non-transitory computer-readable information storage medium for storing a program for causing a computer to execute: acquiring, in association with a predetermined label, actual time series information indicating an operation state of a subject machine being one of a machine or an electric circuit; executing physical simulation of generating a plurality of pieces of virtual time series information by sequentially calculating a virtual state after a unit time based on each of a plurality of parameters representing an internal state of the subject machine; identifying one or more parameter values from the plurality of parameter values based on the plurality of pieces of virtual time series information and the actual time series information, and associating the identified one or more parameter values with the predetermined label; generating a new parameter value and the predetermined label corresponding to the new parameter value based on the one or more parameter values identified in the identifying of the one or more parameter values; generating virtual time series information corresponding to a new internal state by executing the physical simulation through use of the new parameter value; generating new machine learning data by associating the virtual time series information corresponding to the new internal state with the predetermined label corresponding to the new parameter value; and executing, based on the new machine learning data, learning of a neural network model being a neural network which receives the virtual time series information as input and outputs the predetermined label.

According to the at least one aspect of the present invention, it is possible to easily acquire appropriate machine learning data by identifying the parameters representing the internal state of the subject machine and using interpolation values thereof.

### BRIEF DESCRIPTION OF THE DRAWINGS

FIG. 1 is a functional block diagram for illustrating an overall configuration of a machine learning device including a machine learning data generation device according to at least one embodiment of the present invention.

FIG. 2 is a diagram for illustrating an example of a hardware configuration of the machine learning data generation device and the machine learning device.

FIG. 3 is a view for illustrating a ball screw mechanism being an example of a subject machine.

FIG. 4A and FIG. 4B are graphs for showing an example of actual time series information and virtual time series information.

FIG. 5A and FIG. 5B are graphs for showing another example of the actual time series information and the virtual time series information.

FIG. 6A and FIG. 6B are graphs for showing another example of the actual time series information and the virtual time series information.

FIG. 7A and FIG. 7B are graphs for showing another example of the actual time series information and the virtual time series information.

FIG. 8 is a table for showing an example of parameters and labels stored in a parameter storage module.

FIG. 9 is a diagram for showing an example of a parameter distribution diagram.

FIG. 10 is a diagram for illustrating a GAN.

FIG. 11A and FIG. 11B are graphs for showing an example of the virtual time series information including noise.

FIG. 12A and FIG. 12B are graphs for showing another example of the virtual time series information including the noise.

FIG. 13A and FIG. 13B are graphs for showing another example of the virtual time series information including the noise.

FIG. 14A and FIG. 14B are graphs for showing another example of the virtual time series information including the noise.

FIG. 15 is a flowchart of a machine learning data generation method and a machine learning method executed by the machine learning data generation device and the machine learning device according to the at least one embodiment of the present invention.

### DESCRIPTION OF THE EMBODIMENTS

Now, at least one preferred embodiment for carrying out the present invention (hereinafter referred to simply as “embodiment”) is described with reference to the drawings.

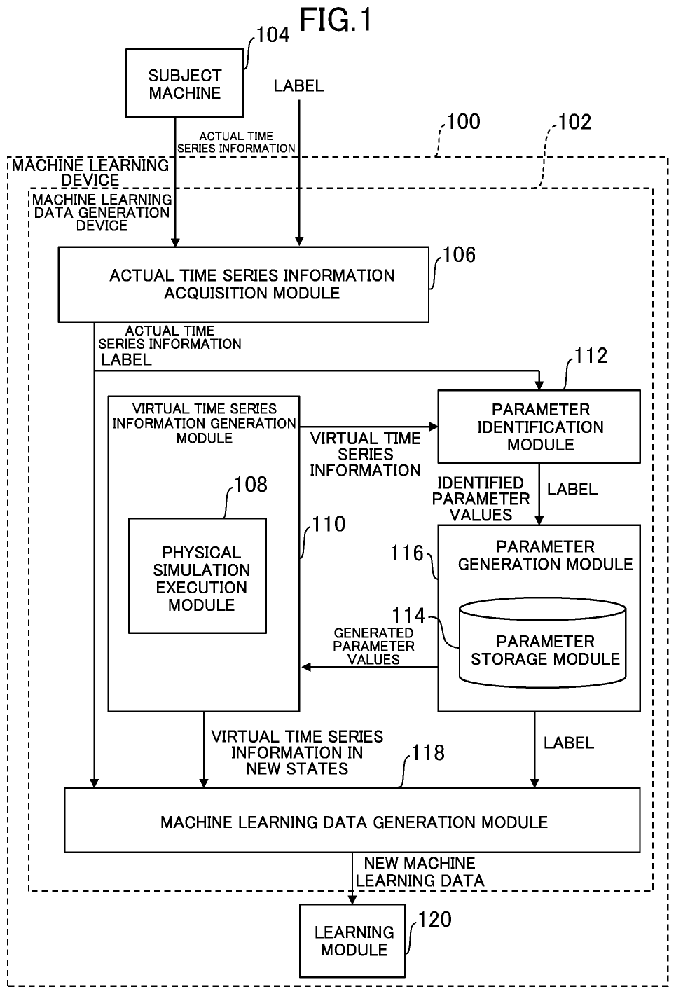

FIG. 1 is a functional block diagram for illustrating an overall configuration of a machine learning device 100 including a machine learning data generation device 102 according to a first embodiment of the present invention. The term “machine learning data generation device” as used herein refers to a device which generates machine learning data, which is teacher data to be used in learning in a machine learning model in which supervised learning is performed, and the term “machine learning device” refers to a device which executes the learning of the machine learning model through use of the machine learning data.

The machine learning device 100 and the machine learning data generation device 102 may physically be provided as independent devices, but are not limited to this example. The machine learning device 100 and the machine learning data generation device 102 may be built in another machine or device as a part of the machine or device, or may be appropriately configured through use of physical components of another machine or device as required. More specifically, the machine learning device 100 and the machine learning data generation device 102 may be implemented by software through use of a general computer.

Further, programs for causing a computer to operate as the machine learning device 100 and the machine learning data generation device 102 may be integrated with each other, or may be executed independently. Further, the programs may be incorporated as modules into other software. Alternatively, the machine learning device 100 and the machine learning data generation device 102 may be built on what is called a server computer, and only functions thereof may be provided to a remote site via a public telecommunication line, for example, the Internet.

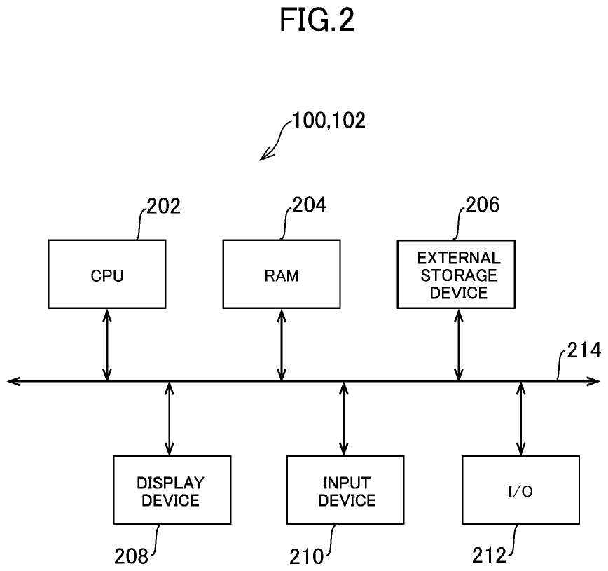

FIG. 2 is a diagram for illustrating an example of a hardware configuration of the machine learning device 100 and the machine learning data generation device 102. FIG. 2 shows a general computer, in which a central processing unit (CPU) 202, which is a processor, a random access memory (RAM) 204, which is a memory, an external storage device 206, a display device 208, an input device 210, and input/output (I/O) 212 are connected by a data bus 214 so that electric signals can be exchanged thereamong. The hardware configuration of the computer described above is merely an example, and another configuration may be employed.

The external storage device 206 is a device in which information can be recorded statically, for example, a hard disk drive (HDD) or a solid state drive (SSD). The display device 208 is, for example, a cathode ray tube (CRT) or what is called a flat panel display, and displays an image. The input device 210 is one or a plurality of devices, for example, a keyboard, a mouse, and a touch panel, to be used by the user to input information. The I/O 212 is one or a plurality of interfaces to be used by the computer to exchange information with external devices. The I/O 212 may include various ports for wired connection, and a controller for wireless connection.

Programs for causing the computer to function as the machine learning device 100 and the machine learning data generation device 102 are stored in the external storage device 206, and are read out by the RAM 204 and executed by the CPU 202 as required. In other words, the RAM 204 stores codes for achieving various functions illustrated as the functional blocks in FIG. 1 by being executed by the CPU 202. Such programs may be provided by being recorded on a computer-readable information recording medium such as an optical disc, a magneto-optical disk, or a flash memory, or may be provided via the I/O 212 through an external information communication line, for example, the

Internet.

The machine learning data generation device 102 includes, as functional components thereof, an actual time series information acquisition module 106, a virtual time series information generation module 110 including a physical simulation execution module 108, a parameter identification module 112, a parameter generation module 116 including a parameter storage module 114, and a machine learning data generation module 118. Further, the machine learning device 100 includes the machine learning data generation device 102 and a learning module 120. The machine learning data generation device 102 is provided to correspond to a subject machine 104 described later. Moreover, the machine learning device 100 executes learning of a machine learning model used by this subject machine 104.

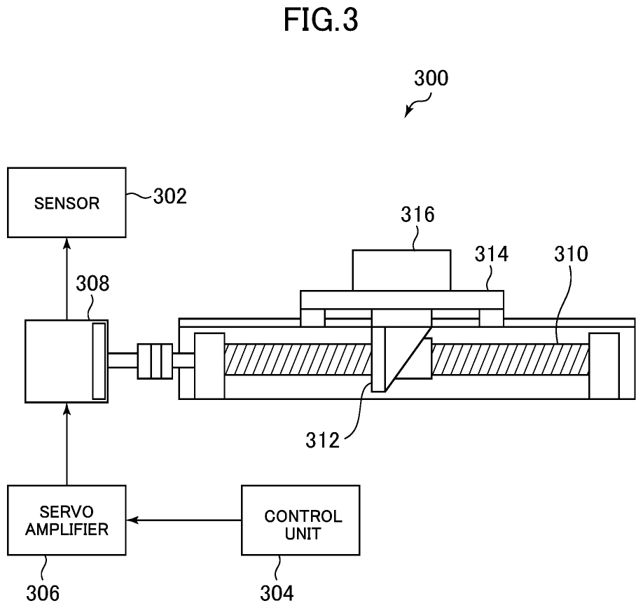

The actual time series information acquisition module 106 acquires, in association with a predetermined label, actual time series information indicating an operation state of the subject machine 104 being a mechanical machine or an electric circuit. The subject machine 104 as used in the present application is a device which executes work of applying a certain physical action to a subject 316. As a specific example, with reference to FIG. 3, description is now given of a case in which the subject machine 104 is a ball screw mechanism 300 which linearly moves the subject 316. The ball screw mechanism 300 itself is known, and the minimum description is thus given thereof.

As illustrated in FIG. 3, the ball screw mechanism 300 includes, for example, a sensor 302, a control unit 304, a servo amplifier 306, a servomotor 308, a ball screw shaft 310, a ball screw nut 312, and a table 314.

The sensor 302 acquires the actual time series information indicating an operation state of each part of the ball screw mechanism 300. Specifically, for example, the sensor 302 is a torque sensor which detects a torque of the servomotor 308. Moreover, the sensor 302 may be an angle sensor which acquires a rotation angle of the ball screw shaft 310 or the servomotor 308 as the actual time series information, a position sensor which acquires a position of the table 314 as the actual time series information, or a voltage sensor or a current sensor which acquires a voltage or a current to be output to the servomotor 308 by the control unit 304 as the actual time series information.

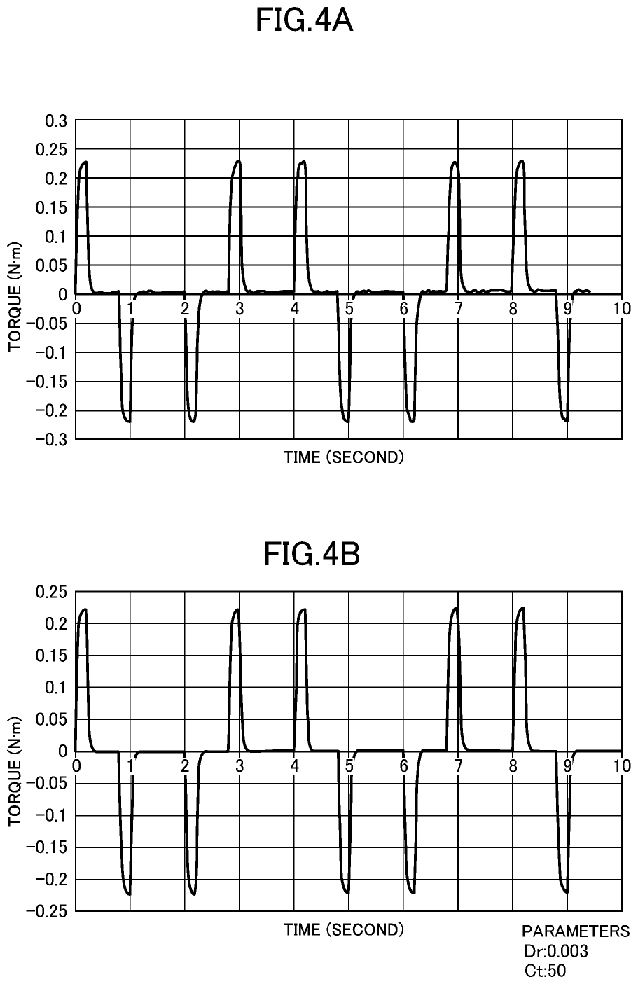

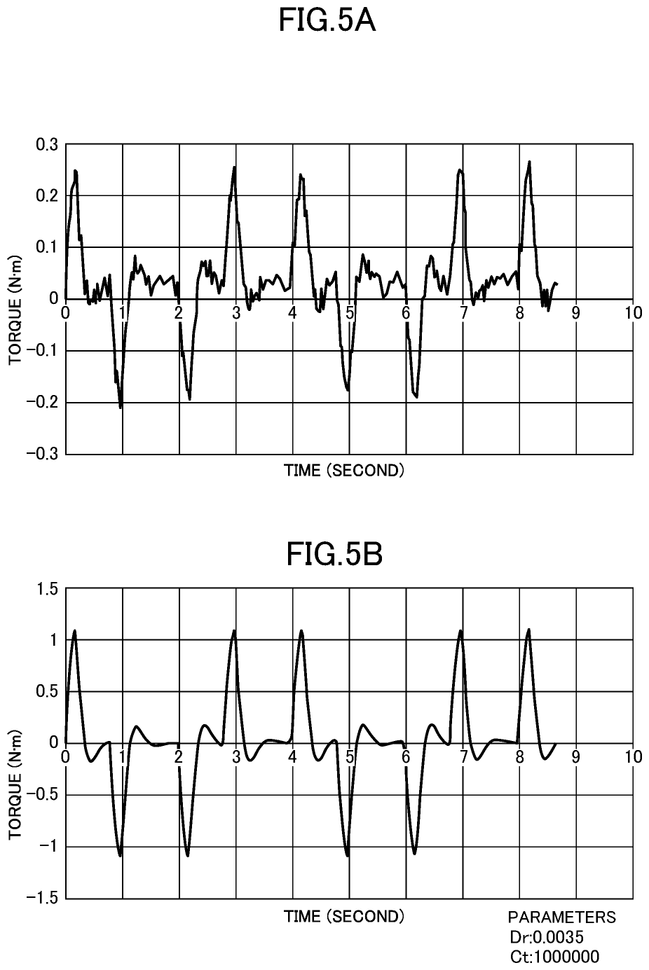

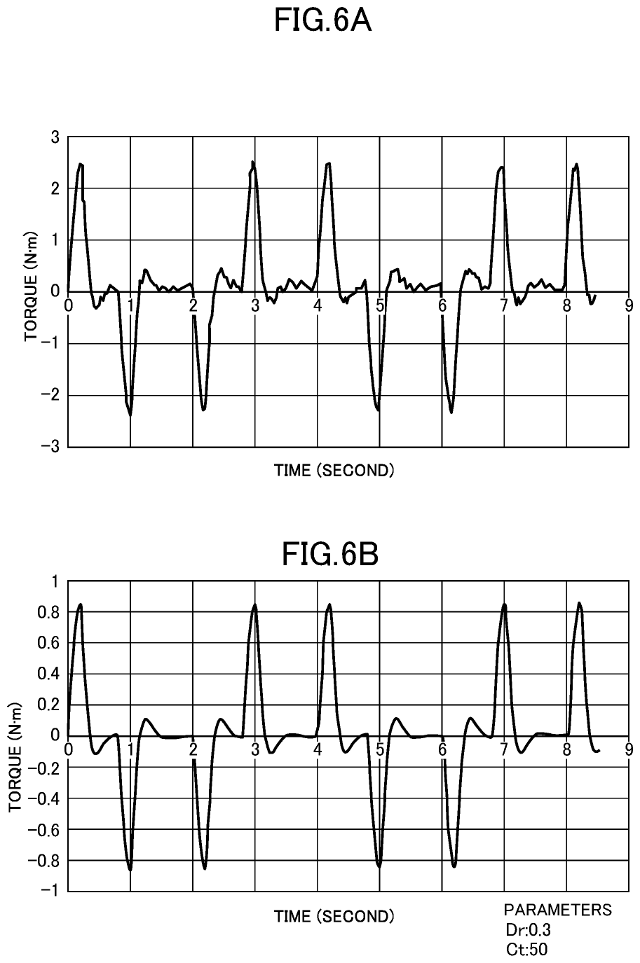

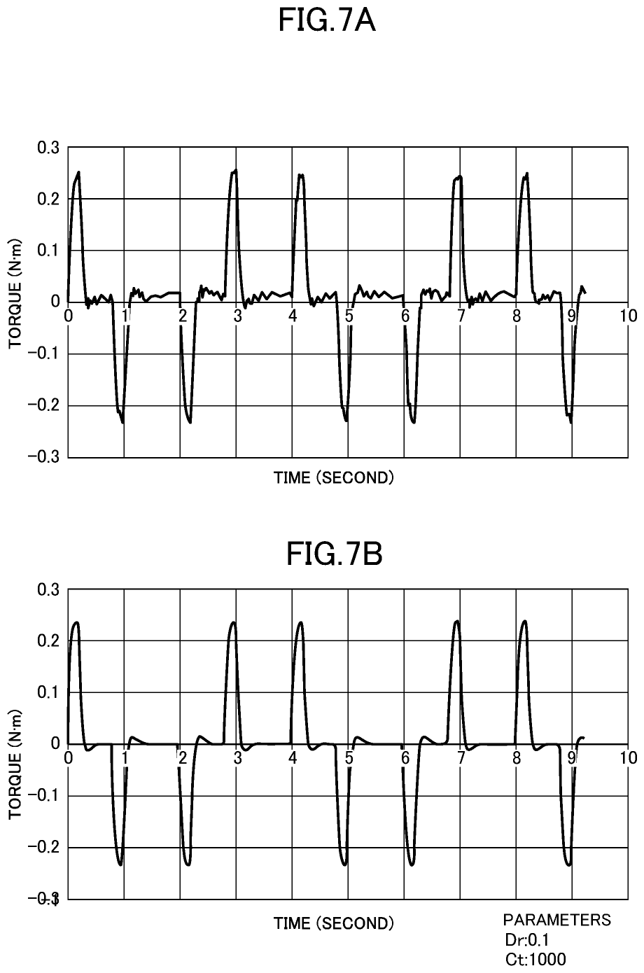

Specifically, for example, the sensor 302 acquires, as the actual time series information, a change with time in the rotation torque of the servomotor 308 shown in FIG. 4A, FIG. 5A, FIG. 6A, and FIG. 7A. Each graph shows the rotation torque of the servomotor 308 at the time when the table 314 repeatedly moves, at intervals of one second, in one direction twice, and then moves in an opposite direction twice.

In this example, when the rotation torque converges to a substantially flat state after each peak, the ball screw mechanism 300 is in a normal state. That is, the actual time series information of FIG. 4A is actual time series information (hereinafter referred to as “normal data”) at the time when the ball screw mechanism 300 being the subject machine 104 is in the normal state. Meanwhile, when the rotation torque does not converge to the flat state after each peak, the ball screw mechanism 300 is in an abnormal state. That is, the actual time series information of FIG. 5A, FIG. 6A, and FIG. 7A is actual time series information (hereinafter referred to as “abnormal data 1,” “abnormal data 2,” and “abnormal data 3,” respectively) at the time when the ball screw mechanism 300 being the subject machine 104 is in the abnormal state.

The control unit 304 is a computer which controls the servo amplifier 306 which outputs the current, the voltage, and the like to the servomotor 308. The control unit 304 may acquire the output of the sensor 302, to thereby execute feedback control for the servo amplifier 306. The servomotor 308 rotates the ball screw shaft 310 based on the current and the voltage acquired from the servo amplifier 306 under the control of the control unit 304. The ball screw nut 312 is fit to the ball screw shaft 310, and moves in an axial direction of the ball screw shaft 310 as a result of the rotation of the ball screw shaft 310. The subject 316 can be moved in the axial direction of the ball screw shaft 310 by arranging the subject 316 to be moved on the table 314 and fixing the table 314 to the ball screw nut 312.

The actual time series information acquisition module 106 acquires the actual time series information indicating the operation state of the ball screw mechanism 300 from the sensor 302 included in the ball screw mechanism 300. For example, the actual time series information acquisition module 106 acquires the rotation angle of the ball screw shaft 310 or the servomotor 308 as the actual time series information. Moreover, the actual time series information acquisition module 106 acquires a label in association with this actual time series information. When the operation state of the subject machine 104 indicated by the actual time series information with which the label is associated is normal or abnormal, for example, the label is a label indicating whether the subject machine 104 is normal or abnormal.

Specifically, for example, the actual time series information acquisition module 106 acquires the actual time series information shown in FIG. 4A, FIG. 5A, FIG. 6A, and FIG. 7A from the subject machine 104. Moreover, the actual time series information acquisition module 106 acquires, when the actual time series information is acquired, the label indicating the state of the ball screw mechanism 300 in association with the actual time series information. In the above-mentioned example, the actual time series information acquisition module 106 acquires the label indicating the normal state in association with the actual time series information shown in FIG. 4A. Moreover, the actual time series information acquisition module 106 acquires the label indicating the abnormal state in association with the actual time series information shown in FIG. 5A, FIG. 6A, and FIG. 7A.

The label associated with the acquired actual time series information may be determined by a user who observes this actual time series information, or may be determined in accordance with an inspection result obtained by a given inspection device without the determination of the user. Moreover, when the operation state indicated by the associated actual time series information is evaluated as levels, the label may be a label indicating excellent, good, acceptable, or not acceptable.

The subject machine 104 is not limited to the ball screw mechanism 300 as long as the subject machine 104 is a device which acquires the actual time series information indicating the operation state of the subject machine 104. For example, the subject machine 104 may be an automatic machine which repeatedly and continuously executes various operations such as picking up components and parts, attaching a component (for example, fitting a bearing to a housing and fastening a screw), packaging (packing foods such as confectioneries in a box), various machining (metal machining such as deburring and polishing, forming and cutting soft objects such as foods, resin forming, and laser machining), and painting and washing.

The virtual time series information generation module 110 includes the physical simulation execution module 108. The physical simulation execution module 108 executes physical simulation of generating a plurality of pieces of virtual time series information by sequentially calculating a virtual state after a unit time based on each of a plurality of parameters representing an internal state of the subject machine 104. The virtual time series information generation module 110 uses the physical simulation execution module 108 to execute physical simulation, to thereby generate the virtual time series information corresponding to the internal state.

The physical simulation execution module 108 in the first embodiment is built so that the physical simulation execution module 108 specifically corresponds to the subject machine 104 which executes a certain physical operation. Details of the physical operation and an application of the subject machine 104 are not particularly limited. For example, the physical simulation execution module 108 in the first embodiment executes the physical simulation based on a model of the ball screw mechanism 300.

Specifically, as a virtual model of the actual ball screw mechanism 300 in a virtual space of the physical simulation execution module 108, there are prepared, in advance, a virtual model of the ball screw mechanism 300 formed of the respective parts being the sensor 302, the control unit 304, the servo amplifier 306, the servomotor 308, the ball screw shaft 310, the ball screw nut 312, and the table 314. The virtual model of the ball screw mechanism 300 includes parameters such as a motor rotation angle (θₘ), a position (xₜ) of the ball screw nut 312 in the ball screw shaft 310 direction at a time “t”, a rotation torque (Tₘ) of the servomotor 308, a moment of inertia (Jᵣ) of a rotational system, a sum (Mₜ) of masses of driven bodies, that is, the ball screw nut 312, the table 314, and the subject 316 placed on the table 314, a viscous friction coefficient (Dᵣ) of the rotational system, a viscous friction coefficient (Cₜ) of a linear motion guide, a diameter (R) of the ball screw shaft 310, and an axial rigidity (Kₜ) of a drive mechanism.

The physical simulation execution module 108 operates the virtual model including the above-mentioned parameters in accordance with a virtual operation command, to thereby simulate the physical operation executed by the subject machine 104 in the virtual space. Behaviors of the virtual model of the respective parts of the ball screw mechanism 300 in the virtual space naturally reproduce a state in which the actual ball screw mechanism 300 is operated.

The physical simulation execution module 108 is built to use the above-mentioned parameter values at a certain time point to output the respective parameter values after the unit time. Specifically, the parameters representing the internal state include parameters which change with time. For example, the ball screw shaft 310 rotates by the servomotor 308 applying the torque to the ball screw shaft 310, to thereby change the position of the ball screw nut 312 in the ball screw shaft 310 direction.

The physical simulation execution module 108 uses the above-mentioned parameter values at a certain time point to output the respective parameter values after the unit time. After that, the physical simulation execution module 108 uses the respective parameter values after the unit time to output the respective parameter values after another unit time. As described above, the physical simulation execution module 108 uses the respective parameter values after the unit time in the next calculation, to thereby use the successively changing parameter values to execute the calculation. Moreover, the virtual time series information generation module 110 unifies the respective parameter values after each unit time output from the physical simulation execution module 108 along the time axis, to thereby generate the virtual time series information corresponding to the internal state of the subject machine 104.

Description is given of an example of the virtual time series information generated by the virtual time series information generation module 110. This description is given of a case in which predetermined initial values are set as the parameters, and the virtual model of the ball screw mechanism 300 operates in accordance with a virtual operation command of moving the table 314 in one direction twice and then moving the table 314 in an opposite direction twice both at intervals of one second.

FIG. 4B, FIG. 5B, FIG. 6B, and FIG. 7B are graphs for showing virtual time series information indicating the change with time in torque of the servomotor 308 generated under such a condition that the viscous friction coefficient Dᵣ of the rotational system and the viscous friction coefficient Cₜ of the linear motion guide given as the initial parameter values are different.

FIG. 4B is a graph for showing virtual time series information on the torque of the servomotor 308 generated when the viscous friction coefficient Dᵣ of the rotational system is 0.003 and the viscous friction coefficient Cₜ of the linear motion guide is 50. FIG. 5B is a graph for showing virtual time series information on the torque of the servomotor 308 generated when the viscous friction coefficient Dᵣ of the rotational system is 0.0035 and the viscous friction coefficient Cₜ of the linear motion guide is 1,000,000. FIG. 6B is a graph for showing virtual time series information on the torque of the servomotor 308 generated when the viscous friction coefficient Dᵣ of the rotational system is 0.3 and the viscous friction coefficient Cₜ of the linear motion guide is 50. FIG. 7B is a graph for showing virtual time series information on the torque of the servomotor 308 generated when the viscous friction coefficient Dᵣ of the rotational system is 0.1 and the viscous friction coefficient Cₜ of the linear motion guide is 1,000.

As a physics engine used for the physical simulation, one corresponding to assumed physical work may be used. When the operation of the ball screw mechanism 300 is assumed as in this example, a physics engine that can execute collision determination and dynamic simulation may be selected or built. When the physical work is different, it should be understood that a physics engine that performs fluid simulation or destruction simulation, or that simulates any other physical phenomenon is selected or built as appropriate. For example, when the subject machine 104 is an electronic circuit, the physical simulation execution module 108 may generate an electric signal which is represented as a voltage or a current, and is output from the electronic circuit while successively changing, as the virtual time series information based on a command input to the electronic circuit.

The parameter identification module 112 identifies one or more parameter values from the plurality of parameter values based on the plurality of pieces of virtual time series information and the actual time series information indicating the operation state, and associates the identified parameter values with the labels. Specifically, for example, the virtual time series information generation module 110 first randomly generates each parameter value within a range of a value which the parameter can physically take, and generates the virtual time series information based on the generated parameter values. The parameter identification module 112 identifies, from among the plurality of virtual time series information generated by the virtual time series information generation module 110, virtual time series information having the smallest error from the actual time series information acquired from the subject machine 104 by the actual time series information acquisition module 106. As a result, the parameter identification module 112 identifies parameter values corresponding to the identified virtual time series information. Moreover, the parameter identification module 112 associates the identified virtual time series information with the same label as a label associated with the actual time series information acquired from the subject machine 104.

For example, the parameter identification module 112 identifies the virtual time series information on the torque of the servomotor 308 shown in FIG. 4B as the virtual time series information having the smallest error from the actual time series information on the torque of the servomotor 308 shown in FIG. 4A. After that, the parameter identification module 112 associates the virtual time series information on the torque of the servomotor 308 shown in FIG. 4B with the label of “normal” associated with the actual time series information on the torque of the servomotor 308 shown in FIG. 4A.

Similarly, the parameter identification module 112 sequentially identifies, as virtual time series information having the smallest error from the actual time series information shown in FIG. 5A, FIG. 6A, and FIG. 7A, the virtual time series information shown in FIG. 5B, FIG. 6B, and FIG. 7B, respectively. Moreover, the parameter identification module 112 associates the virtual time series information shown in FIG. 5B, FIG. 6B, and FIG. 7B with the label of “abnormal” associated with FIG. 5A, FIG. 6A, and FIG. 7A, respectively.

When one parameter value cannot be identified from the plurality of parameter values, the parameter identification module 112 may identify two or more parameter values. For example, there is a case in which a plurality of pieces of virtual time series information having equivalently small errors from the actual time series information are included in the plurality of pieces of virtual time series information generated by the virtual time series information generation module 110. In this case, the parameter identification module 112 identifies parameter values corresponding to the plurality of pieces of virtual time series information. Moreover, the parameter identification module 112 associates the plurality of pieces of identified virtual time series information with the same label as the label associated with the actual time series information acquired from the subject machine 104.

The parameter storage module 114 stores the identified parameter values and the label associated with those parameter values in association with each other. Specifically, the parameter storage module 114 stores each piece of the actual time series information acquired by the actual time series information acquisition module 106, the parameters identified as the parameters corresponding to the actual time series information, and the label associated with the actual time series information in association with one another.

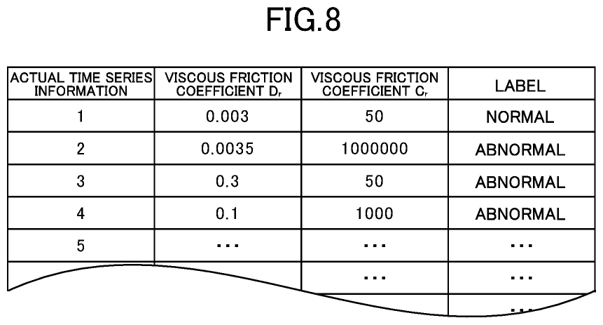

For example, as shown in FIG. 8, the parameter storage module 114 stores each piece of the actual time series information shown in FIG. 4A, FIG. 5A, FIG. 6A, and FIG. 7A, the viscous friction coefficient Dᵣ of the rotational system and the viscous friction coefficient Cₜ of the linear motion guide used to generate the virtual time series information identified as the virtual time series information having the smallest error from the actual time series information, and the label of “normal” or “abnormal” associated with the actual time series information. Values of from 1 to 4 in an actual time series information field of FIG. 8 correspond to the actual time series information shown in FIG. 4A, FIG. 5A, FIG. 6A, and FIG. 7A, respectively.

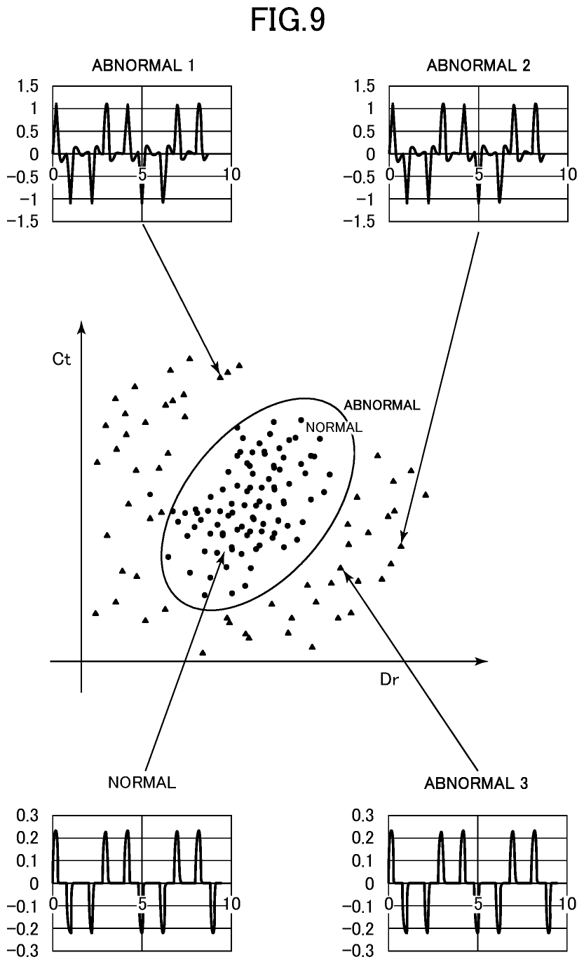

Moreover, the parameter storage module 114 stores possible parameter values for each type of the label in association with the label. Specifically, FIG. 9 is a diagram for showing a relationship among the viscous friction coefficient Dᵣ of the rotational system, the viscous friction coefficient Cₜ of the linear motion guide, and the labels stored in the parameter storage module 114. All of pieces of actual time series information shown in FIG. 9 are the actual time series information acquired by the actual time series information acquisition module 106, and do not include the virtual time series information generated by the virtual time series information generation module 110. As shown in FIG. 9, on a two-dimensional plane having a vertical axis set to the viscous friction coefficient Dᵣ of the rotational system and a horizontal axis set to the viscous friction coefficient Cₜ of the linear motion guide, pieces of actual time series information associated with different labels are unevenly distributed in predetermined regions. A diagram for showing the distribution of the parameter values associated with each of the labels as in FIG. 9 is hereinafter referred to as “parameter distribution diagram.”

That is, the actual time series information (normal data) associated with the “normal” label is distributed inside an ellipsoidal region of FIG. 9, and the actual time series information (abnormal data 1, abnormal data 2, and abnormal data 3) associated with the “abnormal” label is distributed outside the ellipsoidal region of FIG. 9. Those distributions are caused by a difference in relationship between the viscous friction coefficient Dᵣ of the rotational system and the viscous friction coefficient Cₜ of the linear motion guide of the ball screw mechanism 300 depending on whether the ball screw mechanism 300 is in the normally operating state or in the abnormal state.

Accordingly, the parameter values which can be associated with the normal label are the parameter values distributed inside the ellipsoidal region of FIG. 9, and the parameter values which can be associated with the abnormal label are the parameter values distributed outside the ellipsoidal region of FIG. 9. As described above, the parameter storage module 114 stores possible parameter values for each type of the label in association with the label.

In FIG. 9, a border between the actual time series information associated with the different labels is indicated as the ellipsoid, but the border may be set by any method. For example, a position at which a sum of the square of a distance to the closest normal data and the square of a distance to the closest abnormal data is the minimum may be set as the border. Moreover, the position of the border may be set in accordance with the number of pieces of the normal data or the abnormal data within a range of a predetermined distance. Further, the border may not clearly be determined.

The parameter generation module 116 generates new parameter values and the label corresponding to the new parameter values based on the parameter values identified by the parameter identification module 112. For example, the parameter generation module 116 generates new parameter values based on the parameter values stored in the parameter storage module 114 as shown in FIG. 8 and FIG. 9.

Specifically, the parameter generation module 116 generates, as new parameter values, a viscous friction coefficient Dᵣ of the rotational system and a viscous friction coefficient Cₜ of the linear motion guide corresponding to positions at which the data does not exist on the parameter distribution diagram. Those parameter values are parameter values indicating a new internal state which has not been reproduced in the actual ball screw mechanism 300.

Further, the parameter generation module 116 determines, based on a relationship between the new parameter value and a group of the parameter values stored in the parameter storage module 114 and corresponding to each label, the label corresponding to this new parameter value. Specifically, for example, the group of the parameter values existing inside the ellipsoid of FIG. 9 correspond to the “normal” label, and the group of the parameter values existing outside the ellipsoid of FIG. 9 correspond to the “abnormal” label. Thus, when the generated new parameter values exist inside the ellipsoid of FIG. 9, the parameter generation module 116 determines that the label corresponding to the new parameter values is “normal.” Moreover, when the generated new parameter values exist outside the ellipsoid of FIG. 9, the parameter generation module 116 determines that the label corresponding to the new parameter values is “abnormal.”

Depending on the acquired actual time series information, regions in each of which the group of the parameter values stored in the parameter storage module 114 and corresponding to each label are distributed may overlap with each other. That is, there is a case in which the border line shown in FIG. 9 cannot clearly be determined. In this case, the parameter generation module 116 may evaluate a relationship between the new parameter values and the groups of the parameter values stored in the parameter storage module 114 and corresponding to each label, and determine a label corresponding to the new parameter values based on an evaluation result. For example, the parameter generation module 116 may calculate, for each label, a probability distribution function having the position on the parameter distribution diagram as a variable. After that, the parameter generation module 116 may determine, as the label corresponding to the new parameter values, a label having the highest probability of being associated with the newly generated parameter values based on the probability distribution function. As a result, even when the border line shown in FIG. 9 cannot clearly be determined, an appropriate label can be determined as the label corresponding to the new parameter values.

Moreover, the parameter generation module 116 may evaluate, for each label, the number of parameter values existing within a predetermined distance from the new parameter values. In the example of the parameter distribution diagram shown in FIG. 9, the parameter generation module 116 evaluates the number of parameter values associated with each of the normal label and the abnormal label existing in the predetermined distance from the new parameter values. After that, the label associated with the larger number of parameter values may be determined as the label corresponding to the new parameter values.

Moreover, the parameter generation module 116 may selectively generate new parameter values corresponding to the label indicating the abnormality. Specifically, for example, the parameter generation module 116 may selectively generate the new parameter values so that the position of the new parameter values on the parameter distribution diagram shown in FIG. 9 exists outside the ellipsoid. The parameter values existing outside the ellipsoid on the parameter distribution diagram are associated with the label indicating “abnormality.” Thus, the generated new parameter values are associated with the label indicating the abnormality. The state in which the subject machine operates abnormally is not usually reproducible, and it is thus often more difficult to collect the abnormal data than the normal data. The abnormal data can efficiently be collected by the parameter generation module 116 selectively generating new parameter values corresponding to the label indicating the abnormality.

The parameter generation module 116 may generate, as the new parameter values, parameter values indicated by a position at which a predetermined number of parameter values exist within a predetermined range on the parameter distribution diagram. Specifically, as shown in FIG. 9, the new parameter values are indicated by a position on the parameter distribution diagram indicting a distribution of the parameter values with which the labels are associated. The parameter generation module 116 determines a position having a predetermined number of parameter values existing therearound as the position of the newly generated parameter values. For example, the parameter generation module 116 determines the position of the parameter values to be newly generated so that ten or more parameter values exist in a range of ±0.1 of the viscous friction coefficient (Dᵣ) of the rotational system and in a range of ±1,000 of the viscous friction coefficient (Cₜ) of the linear motion guide around the position of the parameter values to be newly generated. As a result, the new parameter values are prevented from being newly generated at a position extremely apart from positions of the parameter values identified based on the actual time series information. Thus, the new parameter values more closely corresponding to the reality are generated. The above-mentioned ranges and number are an example. The new parameter values may be generated so that a predetermined number of parameter values exist within a predetermined range around the position of the new parameter values.

The machine learning data generation module 118 generates new machine learning data by associating the virtual time series information corresponding to the new internal state with the label corresponding to the new parameter values. Specifically, the machine learning data generation module 118 generates new machine learning data by associating, based on the new parameter values generated by the parameter generation module 116, the virtual time series information generated by the virtual time series information generation module 110 and the label corresponding to those parameter values determined by the parameter generation module 116 with each other.

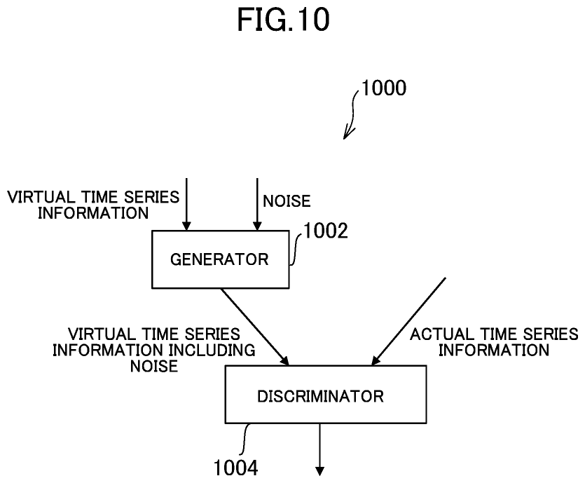

The machine learning data generation module 118 may include a GAN 1000. The general adversarial network (GAN) 1000 generates virtual time series information which is difficult to be distinguished from the actual time series information. With reference to FIG. 10, a brief description is now given of the GAN 1000. The GAN 1000 is known, and hence the description is limited to a minimum description.

The GAN 1000 has a configuration illustrated in FIG. 10, and includes two neural networks referred to as “generator 1002” and “discriminator 1004.” The generator 1002 receives input of the virtual time series information and predetermined noise, and outputs virtual time series information including the noise. Meanwhile, to the discriminator 1004, both of the virtual time series information including the noise generated by the generator 1002 and the actual time series information acquired from the subject machine 104 are input. At this time, whether the input data is the virtual time series information or the actual time series information is not known to the discriminator 1004.

The output of the discriminator 1004 is to discriminate whether the input data is the virtual time series information or the actual time series information. Then, in the GAN 1000, reinforcement learning is performed repetitively for some pieces of virtual time series information and actual time series information prepared in advance, so that both are correctly discriminated in the discriminator 1004, and so that both cannot be discriminated by the discriminator 1004 in the generator 1002.

This eventually results in a state in which both cannot be discriminated by the discriminator 1004 (for example, when the same number of pieces of virtual time series information and pieces of actual time series information are prepared, a percentage of correct answers is 50%). Under such a state, it is considered that the generator 1002 outputs virtual time series information that is indiscernible from the actual time series information and is as close as actual time series information, based on the virtual time series information. Thus, the machine learning data generation module 118 may generate the machine learning data based on the virtual time series information including the noise generated through use of the generator 1002 and the discriminator 1004 for which the above-mentioned learning has been executed.

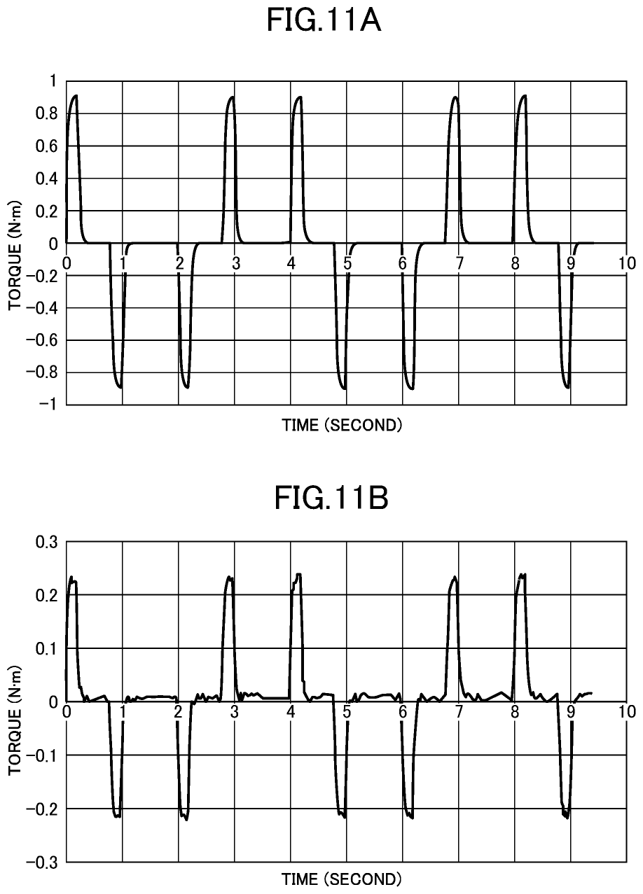

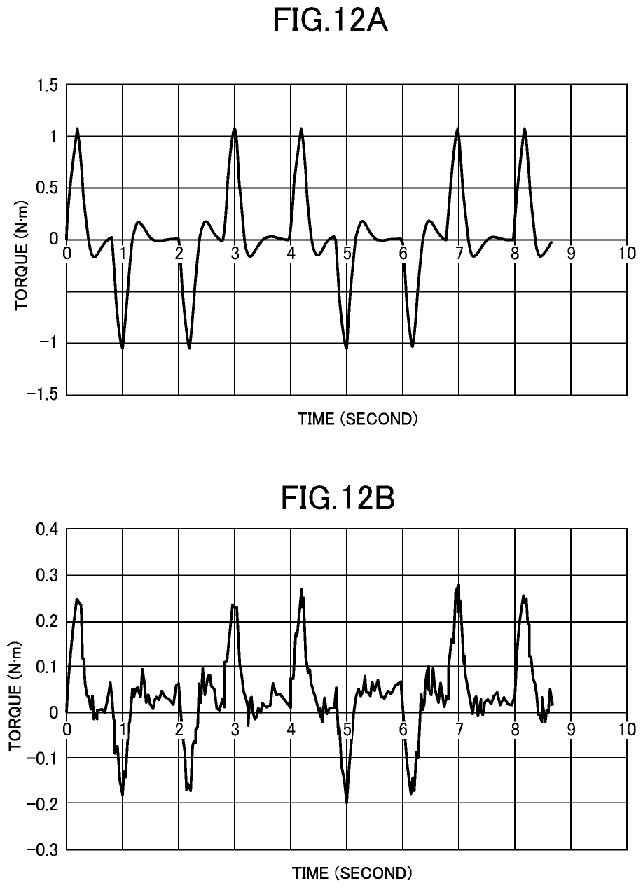

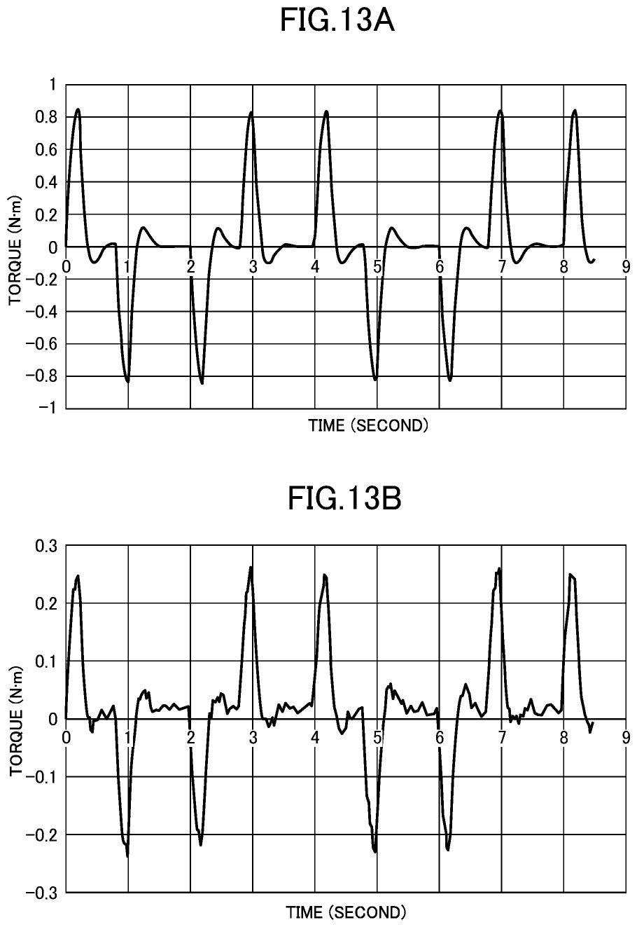

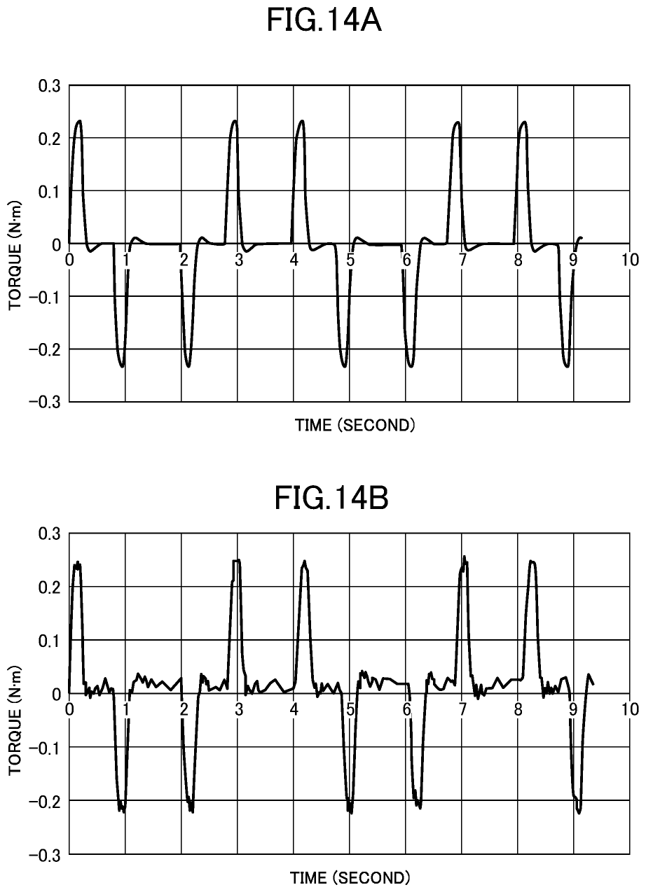

Specifically, for example, when pieces of virtual time series information shown in FIG. 11A, FIG. 12A, FIG. 13A, and FIG. 14A are input to the GAN 1000 included in the machine learning data generation module 118, pieces of virtual time series information including the noise shown in FIG. 11B, FIG. 12B, FIG. 13B, and FIG. 14B are output.

The pieces of virtual time series information of FIG. 11A, FIG. 12A, FIG. 13A, and FIG. 14A are the pieces of virtual time series information shown in FIG. 4B, FIG. 5B, FIG. 6B, and FIG. 7B, respectively. The virtual time series information generated by the virtual time series information generation module 110 does not include noise, and thus has a shape which is hard to acquire from the actual subject machine 104. However, it is difficult to distinguish, at a glance, the virtual time series information including the noise generated by the GAN 1000 from the actual time series information. That is, it is possible to generate the virtual time series information more closely corresponding to the reality by the GAN 1000.

As described above, a large number of pieces of machine learning data different from one another can be obtained easily within practical ranges of time and cost by the machine learning data generation device 102. Even in a mode in which a frequency of failure occurring in the subject device is low, time series information representing the internal state of the subject device in which the failure of this mode has occurred can be used as the learning data by executing physical simulation through use of parameter values reflecting this mode of the failure.

The machine learning device 100 includes the above-mentioned machine learning data generation device 102 and the learning module 120. The learning module 120 executes learning of a neural network model being a neural network which receives the virtual time series information as input and outputs the label based on the machine learning data. Specifically, to the neural network, “n” pieces of machine learning data generated by the machine learning data generation module 118 are input. In this case, “n” is a number sufficient for the machine learning, and is appropriately set. Moreover, when “i” is an integer of from 1 to “n”, machine learning data “i” includes virtual time series information “i” and a label “i”. The neural network receives the virtual time series information “i” as input, and calculates a score.

The score is a value indicating a degree of matching with a predetermined label (in the above-mentioned example, the “normal” label or the “abnormal” label) and is, for example, an output value of a CNN. After that, a comparison result (hereinafter referred to as “error”) between the label “i” input to the learning module 120 in association with the virtual time series information “i” and the score is specified. The error may be data taking a value equal to or larger than 0 and equal to or smaller than 1. The error may be data which takes 1 when the calculated score and the label “i” match each other, and takes 0 when the score and the label “i” do not match with each other.

Further, based on this error, each weight coefficient between nodes of the CNN is updated by, for example, the error back propagation method. The neural network repeats the update of the weight coefficients each time the machine learning data is input while “i” is changed from 1 to “n”. As a result, the learning of the learning module 120 is executed.

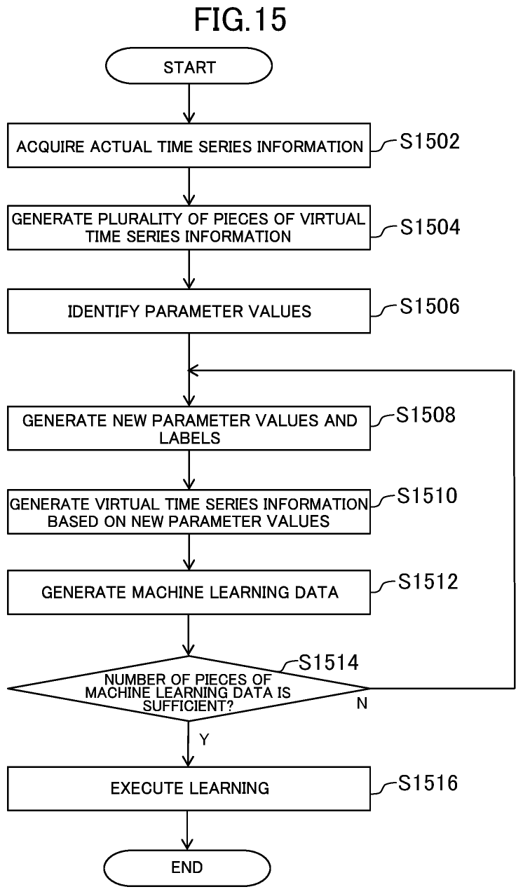

FIG. 15 is a flowchart of a machine learning data generation method and a machine learning method executed by the machine learning device 100 and the machine learning data generation device 102 according to the first embodiment. In the flow of this flowchart, Step S1502 to Step S1514 correspond to the machine learning data generation method, and Step S1502 to Step S1516 correspond to the machine learning method.

First, the actual time series information acquisition module 106 acquires, in association with a predetermined label, actual time series information indicating the operation state of the subject machine 104 being a mechanical machine or an electric circuit (Step S1502). Next, the physical simulation execution module 108 executes the physical simulation of generating a plurality of pieces of virtual time series information by sequentially calculating a virtual state after a unit time based on each of a plurality of parameters representing the internal state of the subject machine 104. The virtual time series information generation module 110 thus generates the virtual time series information corresponding to the internal state (Step S1504).

Next, the parameter identification module 112 identifies one or more parameter values from the plurality of parameter values based on the plurality of pieces of virtual time series information generated in Step S1504 and the actual time series information indicating the operation state, and associates the identified parameter values with the labels (Step S1506). The identified parameter values and the labels associated with those parameter values are stored in the parameter storage module 114. Moreover, in this case, possible parameter values for each type of the label may be stored in association with this label in the parameter storage module 114 by calculating the border or the probability distribution function of each label on the parameter distribution diagram.

Next, the parameter generation module 116 generates new parameter values and the labels corresponding to the new parameter values based on the parameter values identified by the parameter identification module 112 (Step S1508). After that, the virtual time series information generation module 110 uses the new parameter values generated in Step S1508 to execute the physical simulation, to thereby generate the virtual time series information corresponding to the new internal states (Step S1510). The machine learning data generation module 118 associates the virtual time series information corresponding to the new internal states generated in Step S1510 with the labels, to thereby generate new machine learning data (Step S1512). The generated machine learning data is successively accumulated.

In Step S1514, it is determined whether or not the accumulated number of pieces of machine learning data is sufficient. When the number of pieces of machine learning data is not sufficient (Step S1514: N), the process returns to Step S1508, and the generation of the machine learning data is repeated. When the number of pieces of machine learning data is sufficient (Step S1514: Y), the process proceeds to Step S1518. As the required number of pieces of machine learning data, a target number may be determined in advance. Alternatively, a result of the machine learning in Step S1516 is evaluated, and when the learning is not sufficient, Step S1508 to Step S1514 may be executed again to additionally generate the machine learning data. The evaluation of the result of the machine learning may be performed by evaluating convergence of an internal state of the neural network model in the learning module 120, or by inputting test data to the neural network model, and by an accuracy rate of the obtained output.

Next, the learning module 120 executes learning of the neural network model based on the generated machine learning data depending on the achievement status. In this manner, in the first embodiment, the neural network model that has learned is obtained.

As apparent from the example of the ball screw mechanism 300 described in this example, it is not easy to actually prepare a sufficient number of pieces of machine learning data for causing the neural network model in the learning module 120 to fully learn. This is because the ball screw mechanism 300 is formed by assembling the plurality of components, and when the same failure is induced by different components or when a failure is induced by the same component but causes of the failure are different, various failure modes occur. In order to obtain the machine learning data from the ball screw mechanism 300 operating in various different failure modes, it is required to use the actual ball screw mechanism 300 to achieve those various different failure modes. However, this requires too much time and cost, and is thus not realistic.

Meanwhile, according to the first embodiment, the machine learning is executed while the subject machine 104 is not actually prepared in different failure modes. Accordingly, the machine learning device 100 according to the first embodiment can virtually execute the physical operation by the subject machine 104, to thereby generate the sufficient number of pieces of machine learning data for the neural network model with realistic time and cost. Further, the machine learning device 100 according to the first embodiment can execute learning of the neural network model with the generated machine learning data.

Moreover, there is a technology referred to as “VAE” which captures a feature of the machine learning data, encodes the feature into a latent variable, and again generates data similar to machine learning data from the latent variable. With the VAE, it is possible to generate the machine learning data when the subject machine 104 does not actually execute the physical operation. For example, the VAE forms feature vectors from machine learning data such as the output of the sensor 302 provided to the machine, and interpolates the feature vectors to generate new teacher data. However, the VAE simply interpolates the data representing the superficial state of the machine, and hence, when the data output from the machine changes greatly while the internal state of the machine changes slightly, the VAE cannot generate the machine learning data appropriately labeled.

In contrast, according to the first embodiment, the physical simulation execution module 108 executes the physical simulation based on the plurality of parameters representing the internal state of the subject machine 104, and hence the machine learning reflecting the operation of the subject machine 104 can be executed. Moreover, the parameters represent the internal state of the subject machine 104, and hence the ranges of the values that those parameters can take are physically determined. Thus, it is possible to avoid learning to be executed based on virtual time series information generated from unrealistic parameter values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A machine learning data generation device, comprising:
at least one processor; and
at least one memory device that stores a plurality of instructions which, when executed by the at least one processor, causes the at least one processor to execute:
acquiring, in association with a predetermined label, actual time series information indicating an operation state of a subject machine being one of a machine or an electric circuit;
executing physical simulation of generating a plurality of pieces of virtual time series information by sequentially calculating a virtual state after a unit time based on each of a plurality of parameters representing an internal state of the subject machine;
identifying one or more parameter values from the plurality of parameter values based on the plurality of pieces of virtual time series information and the actual time series information, and to associate the identified one or more parameter values with the predetermined label;
generating a new parameter value and the predetermined label corresponding to the new parameter value based on the one or more identified parameter values;
generating virtual time series information corresponding to a new internal state by executing the physical simulation through use of the new parameter value; and
generating new machine learning data by associating the virtual time series information corresponding to the new internal state with the predetermined label corresponding to the new parameter value.

2. The machine learning data generation device according to claim 1,
the at least one memory device further stores the parameter value that is possible for each type of the predetermined label in association with the predetermined label,
wherein the new parameter value is generated based on the parameter stored in the at least one memory device.

3. The machine learning data generation device according to claim 2, wherein the predetermined label corresponding to the new parameter value is determined based on a relationship between the new parameter value and a group of the parameter values stored in the at least one memory device and corresponding to each predetermined label.

4. The machine learning data generation device according to claim 2,
wherein the predetermined label indicates whether the operation state of the subject machine is normal or abnormal, and
wherein the new parameter value corresponding to the predetermined label indicating that the operation state is abnormal is selectively generated.

5. The machine learning data generation device according to claim 3,
wherein the new parameter value is indicated as a position on a parameter distribution diagram representing a distribution of the one or more parameter values associated with the predetermined label, and
wherein the parameter value that is generated as the new parameter value is a parameter value indicated by a position at which a predetermined number of the parameter values exist within a predetermined range on the parameter distribution diagram.

6. The machine learning data generation device according to claim 1, wherein the virtual time series information corresponding to the new internal state is generated by a generative adversarial network (GAN) based on a result of the physical simulation executed through use of the new parameter value.

7. The machine learning data generation device according to claim 2, wherein the virtual time series information corresponding to the new internal state is generated by a generative adversarial network (GAN) based on a result of the physical simulation executed through use of the new parameter value.

8. The machine learning data generation device according to claim 3, wherein the virtual time series information corresponding to the new internal state is generated by a generative adversarial network (GAN) based on a result of the physical simulation executed through use of the new parameter value.

9. The machine learning data generation device according to claim 4, wherein the virtual time series information corresponding to the new internal state is generated by a generative adversarial network (GAN) based on a result of the physical simulation executed through use of the new parameter value.

10. The machine learning data generation device according to claim 5, wherein the virtual time series information corresponding to the new internal state is generated by a generative adversarial network (GAN) based on a result of the physical simulation executed through use of the new parameter value.

11. A machine learning model generation method, comprising:
acquiring, in association with a predetermined label, actual time series information indicating an operation state of a subject machine being one of a machine or an electric circuit;
executing physical simulation of generating a plurality of pieces of virtual time series information by sequentially calculating a virtual state after a unit time based on each of a plurality of parameters representing an internal state of the subject machine;
identifying one or more parameter values from the plurality of parameter values based on the plurality of pieces of virtual time series information and the actual time series information, and associating the identified one or more parameter values with the predetermined label;
generating a new parameter value and the predetermined label corresponding to the new parameter value based on the one or more parameter values identified in the identifying of the one or more parameter values;
generating virtual time series information corresponding to a new internal state by executing the physical simulation through use of the new parameter value;
generating new machine learning data by associating the virtual time series information corresponding to the new internal state with the predetermined label corresponding to the new parameter value; and
executing, based on the new machine learning data, learning of a neural network model being a neural network which receives the virtual time series information as input and outputs the predetermined label.

12. A Non-transitory computer-readable information storage medium for storing a program for causing a computer to execute:
acquiring, in association with a predetermined label, actual time series information indicating an operation state of a subject machine being one of a machine or an electric circuit;
executing physical simulation of generating a plurality of pieces of virtual time series information by sequentially calculating a virtual state after a unit time based on each of a plurality of parameters representing an internal state of the subject machine;
identifying one or more parameter values from the plurality of parameter values based on the plurality of pieces of virtual time series information and the actual time series information, and associating the identified one or more parameter values with the predetermined label;
generating a new parameter value and the predetermined label corresponding to the new parameter value based on the one or more parameter values identified in the identifying of the one or more parameter values;
generating virtual time series information corresponding to a new internal state by executing the physical simulation through use of the new parameter value;
generating new machine learning data by associating the virtual time series information corresponding to the new internal state with the predetermined label corresponding to the new parameter value; and
executing, based on the new machine learning data, learning of a neural network model being a neural network which receives the virtual time series information as input and outputs the predetermined label.
